(19) United States
(12) Patent Application Publication
(10) Pub. No.: US 2003/0166446 A1
(43) Pub. Date: Sep. 4, 2003

(54) High temperature glass fiber insulation

(76) Inventor: Albert Lewis, Chino, CA (US)

Correspondence Address: Boniard I. Brown, 1500 West Covina Parkway, #113, West Covina, CA, 91790-2793, US

(21) Appl. No.: 10/090,346

(22) Filed: Mar. 4, 2002

(51) Int. Cl. C03C 6/00; C03C 13/02; C03C 13/06

(52) U.S. Cl. 501/27; 501/36; 501/38

(57) ABSTRACT

An improved glass composition for glass fibers having high heat resistance properties without melting, and typically comprising standard glass raw materials.

### BACKGROUND AND SUMMARY OF THE INVENTION

The present invention relates to glass compositions and particularly to glass compositions having good fiberizing characteristics, high strength, high durability at high temperatures, and high modulus of elasticity.

There has existed a demand for fiber glass compositions which can be successfully formed into fibers, particularly for use in insulation and acoustical products.

Problems of achieving those characteristics at relatively low cost have long been recognized in the glass art, but no satisfactory compositions have been available for forming long and small diameter glass fibers having the desired characteristics.

The problems associated with the achieving of such characteristics and providing an appropriate product at reasonable costs have long been recognized in the glass art.

High temperature glass compositions have heretofore been produced, but they are subject to the shortcomings of having a short working temperature range or being too expensive to produce due to the high costs of raw material and/or energy requirements.

Fibers for aircraft insulation are of particular importance, particularly for commercial aircraft. The Federal Aviation Administration has long dictated aircraft be made safer.

Aircraft have been destroyed and people's lives lost by fire, and crashes. Examples are an MD-11 which burned and was destroyed in Canada, and an MD-80 which was destroyed by fire and crashed in Texas, and many others. These crashes were blamed on insulation blankets which caught fire and burned. The blankets embodied fibers which were relatively low-temperature fibers and so melted at high temperatures.

An object of the invention is to provide a glass which has good insulation acoustical properties, high strength, a high to modulus of elasticity and high temperature resistance properties.

Another object is to provide a glass which has high strength and which can be drawn into long, strong glass fibers.

Substantial cost reductions are achieved because of the utilization of relatively inexpensive raw materials and lower energy use, which provide high temperature resistance, good insulation acoustical properties and high strength.

Very little refining is required to provide freedom from impurities, thus allowing continuous or discontinuous fibers to be manufactured with relative ease.

The glass compositions of this invention can be formed into long and/or short, stable glass fibers.

### DESCRIPTION OF THE PREFERRED EMBODIMENTS

The present invention relates to glass compositions and particularly to glass compositions having good fiberizing characteristics, high strength, high durability at high temperatures, and high modulus of elasticity.

In the course of research effort and development work relative to the present invention, a wide range of fiber diameters were investigated, such range being from 0.5 to 5 microns. High temperature insulation values were obtained throughout such range.

High temperature insulation values were obtained throughout the range of, and independent of, fiber diameters.

The glass specimens were prepared utilizing a specific raw material which included silica, alumina, titania, zirconia and other oxides.

Glasses of this invention were prepared by melting raw batch material in the following approximate ranges of temperatures: between about 2,600° F. to about 2,900° F., utilizing conventional refractory containers.

Glass compositions according to the invention have a liquidous temperature of approximately 2,400° F., which is suitable for glass forming.

The glass can be formed into fibers for insulation and acoustical parts using the centrifugal rotary process (vertical and horizontal), or blowing and flame processes. It can also be drawn into continuous and staple fibers.

The material of the invention differs from other high temperature glasses in that, the fibers of the invention differ from prior art in that the material of the invention has good resistance to devitrification at the forming temperature, and requires lower processing energy than other high temperature fibers.

The molten glass may also be formed into fibers on a conventional drawing wheel, at speeds up to 12,000 feet per minute at temperatures between 2,400° F. to about 2,900° F. Speeds between about 3,000 to about 10,000 feet per minute are preferable in order to provide optimum filament properties. Fibers may be drawn from about 9 microns to about 14 microns in diameter. Diameters of about 9 microns are preferred. Fibers were produced using the centrifugal, blowing and flame processes.

In this research work, resultant fibers were collected on a metal conveyor, and maintained thereon during the rest of the manufacture process.

Compositions according to the present invention provide a reduction of cost of approximately 20% when compared to other high

TYPICAL BATCH BLENDS

| Raw Materials | Oxide Weights | | |
|---|---|---|---|
| Silica Sand | 243.86 | 249.33 | 251.35 |
| Iron Oxide | 35.75 | 26.15 | 22.31 |
| Kaolin | 94.92 | 97.15 | 98.09 |
| Soda Ash | 8.47 | 8.68 | 8.72 |
| Dolomite Limestone | 44.84 | 44.03 | 46.68 |
| Titania Dioxide | 3.65 | 3.73 | 3.75 |
| Manganese Dioxide | 0.90 | 1.0 | 1.25 |

Fibers according to the present invention, for insulation blankets, may have the following components having the following ranges of percentages:

Compositional Range

| Oxides | Oxide Weight % | | |
|---|---|---|---|
| SiO₂ | 10.23 | to | 81.81 |
| Al₂O₃ | 2.0 | to | 25.91 |
| Na₂O | 0 | to | 5.80 |
| K₂O | 0 | to | 5.70 |
| CaO | 3.76 | to | 10.5 |
| MgO | 1.84 | to | 10.5 |
| Fe₂O | 4.64 | to | 15.5 |
| TiO₂ | 0 | to | 3.0 |
| Zr₂O | 0 | to | 5.0 |
| MnO | 0 | to | 6.0 |

temperature fibers, because of the use of less expensive raw materials, and lower energy requirements in processing them into glass fibers. In addition, it has been determined that less binder is required than in known, commercially available compositions due to the improved surface condition and high strength of the fibers.

Insulation fiber diameters may range from about 0.5 to 5 microns. All of the above processes may be utilized to manufacture glass fibers in the above noted diameter range.

In the course of development research, it has been postulated that the results obtained are provided by the amorphous glass fibers being converted during the burn-through tests into a ceram glass which forms a fiber mat in which the fiber integrity is maintained, thus preventing high temperatures from penetrating the insulation blanket containing the fibers according to the invention.

Temperatures as high as 2,200° F. are withstood, as in aircraft insulation blankets, for several hours.

The following typical batch blends were mixed and melted in a refractory furnace and the resultant glasses were successfully fiberized into continuous glass fibers:

Set forth below are illustrative examples of exemplary embodiments of the present invention.

EXAMPLE 1

| Oxides | Weight Percent |
|---|---|
| SiO₂ | 46.23 |
| Al₂O₃ | 25.91 |
| Na₂O | 2.40 |
| K₂O | 0.82 |
| CaO | 8.27 |
| MgO | 4.06 |
| Fe₂O₃/FeO | 10.22 |
| TiO₂ | 1.58 |
| Zr₂O | 0.01 |
| P₂O₅ | 0.28 |
| MnO | 0.23 |

EXAMPLE 2

| Oxides | Weight Percent |
|---|---|
| SiO₂ | 58.12 |
| Al₂O₃ | 11.15 |
| Na₂O | 2.24 |
| K₂O | 0.76 |
| CaO | 7.71 |
| MgO | 3.78 |
| Fe₂O₃/FeO | 9.52 |
| TiO₂ | 1.48 |
| Zr₂O | 4.77 |
| P₂O₅ | 0.26 |
| MnO | 0.22 |

EXAMPLE 3

| Oxides | Weight Percent |
|---|---|
| SiO₂ | 62.95 |
| Al₂O₃ | 11.13 |
| Na₂O | 2.24 |
| K₂O | 0.76 |
| CaO | 7.70 |
| MgO | 3.77 |
| Fe₂O₃/FeO | 9.51 |
| TiO₂ | 1.47 |
| Zr₂O | 0.01 |
| P₂O₅ | 0.26 |
| MnO | 0.22 |

EXAMPLE 4

| Oxides | Weight Percent |
|---|---|
| SiO₂ | 53.69 |
| Al₂O₃ | 13.84 |
| Na₂O | 2.79 |
| K₂O | 0.95 |
| CaO | 9.61 |
| MgO | 4.71 |
| Fe₂O₃/FeO | 11.87 |
| TiO₂ | 1.83 |
| Zr₂O | 0.08 |
| P₂O₅ | 0.32 |
| MnO | 0.27 |

EXAMPLE 5

| Oxides | Weight Percent |
|---|---|
| SiO₂ | 55.25 |
| Al₂O₃ | 18.25 |
| Na₂O | 2.30 |
| K₂O | 1.80 |
| CaO | 8.38 |
| MgO | 3.97 |
| Fe₂O₃/FeO | 8.50 |
| TiO₂ | 1.09 |
| Zr₂O | 0.31 |
| P₂O₅ | 0.20 |
| MnO | 0.18 |

EXAMPLE 6

| Oxides | Weight Percent |
|---|---|
| SiO₂ | 67.55 |
| Al₂O₃ | 9.76 |
| Na₂O | 1.96 |
| K₂O | 0.67 |
| CaO | 6.74 |
| MgO | 3.30 |
| Fe₂O₃/FeO | 8.32 |
| TiO₂ | 1.28 |
| Zr₂O | 0.01 |
| P₂O₅ | 0.22 |
| MnO | 0.19 |

EXAMPLE 7

| Oxides | Weight Percent |
|---|---|
| SiO₂ | 70.02 |
| Al₂O₃ | 10.14 |
| Na₂O | 2.03 |
| K₂O | 0.01 |
| CaO | 6.53 |
| MgO | 4.26 |
| Fe₂O₃/FeO | 5.26 |
| TiO₂ | 1.33 |
| Zr₂O | 0 |
| P₂O₅ | 0 |
| MnO | 0 |

It will be understood that various changes and modifications may be made from the preferred embodiments discussed above without departing from the scope of the present invention, which is established by the following claims and equivalents thereof.

The inventor claims:

1. A batch blend to produce a glass composition useful for forming glass fibers of high heat resistance, comprising:
SiO₂ in an amount ranging from about 10.23 to about 81.81 weight percent,
Al₂O₃ in an amount ranging from about 2.0 to about 25.91 weight percent,
Na₂O in an amount ranging from about 0 to about 5.80 weight percent,
K₂O in an amount ranging from about 0 to about 5.70 weight percent,
CaO in an amount ranging from about 3.76 to about 10.5 weight percent,
MgO in an amount ranging from about 1.84 to about 10.5 weight percent,
Fe₂O₃ in an amount ranging from about 4.64 to about 15.5 weight percent,
TiO₂ in an amount ranging from about 0.72 to about 3.0 weight percent,
ZrO in an amount ranging from about 0.003 to about 5.0 weight percent, and
MnO in an amount ranging from about 0.11 to about 6.0 weight percent.

2. The batch blend of claim 1, wherein the resulting composition is essentially free of Na₂O and K₂O.

3. A batch blend to produce a glass composition useful for forming glass fibers of high heat resistance, comprising:
SiO₂ in an amount of about 46.23 weight percent,
Al₂O₃ in an amount of about 25.91 weight percent,
Na₂O in an amount of about 2.40 weight percent,
K₂O in an amount of about 0.82 weight percent,
CaO in an amount of about 8.27 weight percent,
MgO in an amount of about 4.06 weight percent,
Fe₂O₃/FeO in an amount of about 10.22 weight percent,
TiO₂ in an amount of about 1.58 weight percent,
Zr₂O in an amount of about 0.01 weight percent,
P₂O₅ in an amount of about 0.28 weight percent, and
MnO in an amount of about 0.23 weight percent.

4. The batch blend of claim 3, wherein the resulting composition is essentially free of Zr₂O.

5. A batch blend to produce a glass composition useful for forming glass fibers of high heat resistance, comprising:
SiO₂ in an amount of about 58.12 weight percent,
Al₂O₃ in an amount of about 11.15 weight percent,
Na₂O in an amount of about 2.24 weight percent,
K₂O in an amount of about 0.76 weight percent,
CaO in an amount of about 7.71 weight percent,
MgO in an amount of about 3.78 weight percent,
Fe₂O₃/FeO in an amount of about 9.52 weight percent,
TiO₂ in an amount of about 1.48 weight percent,
Zr₂O in an amount of about 4.77 weight percent,
P₂O in an amount of about 0.26 weight percent, and
MnO in an amount of about 0.22 weight percent.

6. A batch blend to produce a glass composition useful for forming glass fibers of high heat resistance, comprising:
SiO₂ in an amount of about 62.95 weight percent,
Al₂O₃ in an amount of about 11.13 weight percent,
Na₂O in an amount of about 2.24 weight percent,
K₂O in an amount of about 2.24 weight percent,
CaO in an amount of about 0.76 weight percent,
MgO in an amount of about 3.77 weight percent,
Fe₂O₃/FeO in an amount of about 9.51 weight percent,
TiO₂ in an amount of about 1.47 weight percent,
Zr₂O in an amount of about 0.01 weight percent,
P₂O₅ in an amount of about 0.26 weight percent, and
MnO in an amount of about 0.22 weight percent.

7. The batch blend of claim 6, wherein the resulting composition is essentially free of Zr₂O.

8. A batch blend to produce a glass composition useful for forming glass fibers of high heat resistance, comprising:
SiO₂ in an amount of about 53.69 weight percent,
Al₂O₃ in an amount of about 13.84 weight percent,
Na₂O in an amount of about 2.79 weight percent,
K₂O in an amount of about 0.95 weight percent,
CaO in an amount of about 9.61 weight percent,
MgO in an amount of about 4.71 weight percent,
Fe₂O₃/FeO in an amount of about 11.87 weight percent,
TiO₂ in an amount of about 1.83 weight percent,
Zr₂O in an amount of about 0.08 weight percent,
P₂O₅ in an amount of about 0.32 weight percent, and
MnO in an amount of about 0.27 weight percent.

9. A batch blend to produce a glass composition useful for forming glass fibers of high heat resistance, comprising:
SiO₂ in an amount of about 55.25 weight percent,
Al₂O₃ in an amount of about 18.25 weight percent,
Na₂O in an amount of about 2.30 weight percent,
K₂O in an amount of about 1.80 weight percent,
CaO in an amount of about 8.38 weight percent,
MgO in an amount of about 3.97 weight percent,
Fe₂O₃/FeO in an amount of about 8.50 weight percent,
TiO₂ in an amount of about 1.09 weight percent,
Zr₂O in an amount of about 0.31 weight percent,
P₂O₅ in an amount of about 0.20 weight percent, and
MnO in an amount of about 0.18 weight percent.

10. A batch blend to produce a glass composition useful for forming glass fibers of high heat resistance, comprising:
SiO₂ in an amount of about 67.55 weight percent,
Al₂O₃ in an amount of about 9.76 weight percent,
Na₂O in an amount of about 1.96 weight percent,
K₂O in an amount of about 0.67 weight percent,
CaO in an amount of about 6.74 weight percent,
MgO in an amount of about 3.30 weight percent,
Fe₂O₃/FeO in an amount of about 8.32 weight percent,
TiO₂ in an amount of about 1.28 weight percent,
Zr₂O in an amount of about 0.01 weight percent,
P₂O₅ in an amount of about 0.22 weight percent, and
MnO in an amount of about 0.19 weight percent.

11. The batch blend of claim 10, wherein the resulting composition is essentially free of Zr₂O.

12. A batch blend to produce a glass composition useful for forming glass fibers of high heat resistance, comprising:
SiO₂ in an amount of about 70.02 weight percent,
Al₂O₃ in an amount of about 10.14 weight percent,
Na₂O in an amount of about 2.03 weight percent,
K₂O in an amount of about 0.01 weight percent,
CaO in an amount of about 6.53 weight percent,
MgO in an amount of about 4.26 weight percent,
Fe₂O₃/FeO in an amount of about 5.26 weight percent,
TiO₂ in an amount of about 1.33 weight percent,
Zr₂O in an amount of about 0 weight percent,
P₂O₅ in an amount of about 0 weight percent, and
MnO in an amount of about 0 weight percent.
